(19) United States
(12) Patent Application Publication
(10) Pub. No.: US 2017/0030328 A1
(43) Pub. Date: Feb. 2, 2017

(54) NACELLE OF A WIND TURBINE

(71) Applicant: WOBBEN PROPERTIES GMBH, Aurich (DE)

(72) Inventors: Wilko GUDEWER, Norden (DE); Ihno COORDES, Ihlow (DE); Frank KNOOP, Aurich (DE); Peter GEIKEN, Emden (DE); Thorsten FLESSNER, Aurich (DE)

(21) Appl. No.: 15/302,158

(22) PCT Filed: Apr. 2, 2015
(86) PCT No.: PCT/EP2015/057377

§ 371 Date: Oct. 5, 2016

(30) Foreign Application Priority Data
Apr. 7, 2014 (DE) 10 2014 206 703.0
Apr. 9, 2014 (DE) 10 2014 206 880.0

(51) Int. Cl. F03D 1/00; F03D 80/70; F03D 13/40; F03D 9/00; F03D 9/25; F03D 80/80; F03D 7/02

(52) U.S. Cl. CPC F03D 1/005; F03D 80/88; F03D 80/82; F03D 80/70; F03D 7/0204; F03D 9/002; F03D 9/25; F03D 13/40

(57) ABSTRACT

A nacelle of a wind turbine, the wind turbine having a generator for generating electrical energy from wind, and the nacelle comprising a mainframe for carrying the generator on a tower, a carrier module for accommodating items of electrical control equipment, and a nacelle casing for protecting the carrier module and the mainframe against effects of weather, the carrier module and/or the nacelle casing being connected to the mainframe by means of decoupling means, such that there exists thereby an elastically damped connection to the mainframe.

### BACKGROUND

Technical Field

The present invention relates to a nacelle of a wind turbine, and to a method for producing a nacelle of a wind turbine. The present invention additionally relates to a wind turbine.

Description of the Related Art

Wind turbines are known, and by far the most common type is a so-called horizontal-axis wind turbine, in which an aerodynamic rotor is driven by the wind and rotates about a substantially horizontal axis. The rotor drives a generator, and the present invention relates, in particular, to a direct-drive wind turbine, in which the aerodynamic rotor is directly coupled to the generator, namely, to its electrodynamic rotor, or generator-rotor.

The generator, and thus consequently also the aerodynamic rotor, are carried by a mainframe on a tower. In addition, a yaw adjustment, namely, alignment of the rotor in relation to the wind, can usually be achieved by means of a yaw bearing between the mainframe and the tower. At least the generator, the mainframe and further elements necessary for controlling the wind turbine are accommodated in a nacelle, which, by means of a nacelle casing or nacelle outer skin or the like, protects these elements against the effects of weather, in particular against precipitation and wind.

Such nacelles are known in principle, but may have some problems. These include the problem that, particularly in rotating parts, such as the generator, noise is produced, which the nacelle emits outwards as audible sound. Moreover, the provision of such nacelles in situ for the purpose of erecting a wind turbine is very demanding of resources because, in the case of modern wind turbines, in particular direct-drive wind turbines, such nacelles are of sizes that can scarcely any longer be transported by road and that have to be dismantled for transport, or that necessitate a different type of production at the erection site. Accordingly, in this case it is also necessary to take account of the problems of sound emission and also, obviously, the necessity of protection against the influence of weather.

Already known in the art is the practice of preparing such a nacelle in component parts, and then transporting these components parts to the erection site and assembling them there, but this itself still involves transport complexity. The transporting of elements, in particular precision-manufactured elements that are subsequently to be assembled in a sealing manner, additionally involves the risk that damage during transport will limit the functional capability.

This not only necessitates a repair or other action at the installation site, but may possibly also affect the design calculations, such as calculated loads, and might even mean that existing certifications for certain properties are no longer applicable.

In the priority application relating to the present application, the German patent and Trade Mark Office has searched the following prior art: US 2007/0090269 A1 and DE 10 2010 043 435 A1.

### BRIEF SUMMARY

One or more embodiments are directed to reducing a sound emission of the nacelles and/or that renders the erection of a wind turbine as inexpensive as possible, particularly in respect of the production and/or provision of the nacelle.

Proposed is a nacelle having a mainframe, a carrier module and a nacelle casing. The carrier module accommodates items of electrical control equipment, and may also be referred to as an E-module. The nacelle casing is designed to protect at least the carrier module, including the electrical control devices accommodated therein, and the mainframe against the effects of weather. The nacelle casing thus offers substantially a closed envelope. Although the closed envelope may have ventilation openings or entrance or exit hatches, they are designed such that, in normal operation, i.e., in particular when the hatches are closed, there is protection against the effects of weather, in particular against precipitation and wind. For the closed envelope as a whole, a distinction is made between the nacelle casing in the region of the carrier module, the generator casing in the region of the generator, and the spinner casing, which encloses all parts that rotate jointly with the rotor hub.

It is now proposed that the carrier module and additionally, or alternatively, the nacelle casing be connected to the mainframe by means of decoupling means, such that there exists thereby an elastically damped connection to the mainframe. This is proposed, in particular, for the carrier module, which is thus connected to the mainframe by means of these decoupling means. In particular, by means of these decoupling means it is carried by the mainframe, and preferably a bearing connection to the mainframe exists exclusively by means of these decoupling means. Clearly, other connections such as, for example, electrical lines, or protective covers that cover a separating gap between the mainframe and the carrier module, may be in contact with both elements, i.e., the mainframe and the carrier module, which may also apply, moreover, to the nacelle casing, but the bearing function in this case is performed only by means of these decoupling means. The decoupling means thus has the effect that the carrier module is carried by the mainframe, but is otherwise decoupled from the mainframe. In particular, the transmission of structure-borne sound from the mainframe to the carrier module is prevented. It may possibly be the case that the transmission of structure-borne sound cannot be prevented entirely, but transmission is at least significantly prevented, or damped.

This is because it was recognized that substantial sound, which is also ultimately emitted by the nacelle as emitted sound and perceived as sound in the environment, is produced by the generator and is transferred from the latter, firstly into the nacelle and then ultimately into the nacelle casing, which then, as a resonant body, firstly emits this sound, even occasionally amplifying it, or converting it from structure-borne sound into the emitted sound. Instead of redesigning the nacelle such that it no longer emits the sound, or emits it to a lesser extent, the solution proposed here is to significantly prevent the structure-borne sound from being transmitted from the mainframe to the nacelle envelope, especially via the carrier module to the nacelle casing.

Consequently in this case, the entire carrier module, and according to one embodiment, including the entire nacelle casing, is thus carried on the mainframe by means of these decoupling means. For example, four bearing points, and therefore four decoupling means, may be provided, which are distributed as uniformly as possible, in order to accommodate the weight of the carrier module as uniformly as possible.

Such decoupling means may have, for example, rubber rings or similar, in which the carrier module is inserted, by means of corresponding locating pins or the like. Additionally or alternatively, other decoupling means are possible, which may also have, for example, active damping elements, such as damping cylinders.

Preferably, it is proposed that the nacelle casing be fastened to the carrier module by means of decoupling means, a spinner casing be fastened to a rotor of the generator, or generator-rotor, by means of decoupling means, and/or a generator casing be fastened to a stator of the generator by means of decoupling means. At these transitions to the respective casing, or to the respective casing portion, there is thereby created a decoupling connection, namely, in particular, a connection that decouples sound, which, for the corresponding casing elements or casing portions, prevents the admission of structure-borne sound, and consequently prevents the emission of sound. The decoupling means are adapted to the respective function, namely, especially to the loads that they each have to carry, and to the direction of force, which may change continually during operation, especially for the case of the rotating spinner casing. Otherwise, however, they are similar to each other, such that, for simplification, the same term, namely decoupling means, is used for the differing connections.

Preferably, the decoupling means are designed such that they prevent the transmission of structure-borne sound. Preferably, such decoupling means may be settable, in particular settable online, for the purpose of adapting to variable sound emission. For example, the frequency of the structure-borne sound, the transmission of which is to be prevented, may depend on the rotational speed of the generator. A setting capability could take account of this. Environmental conditions, such as the temperature frequency and/or amplitude of the structure-borne sound in the mainframe, might also be influencing factors.

Also possible is a single, non-recurring setting capability that may be effected during or shortly prior to the erection of an actual wind turbine. It is thereby possible to achieve a setting capability individualized to the actual wind turbine and/or to the actual site. The environment may also be a factor in this case, namely, what sound the environment transmits or absorbs or amplifies, or drowns out because of existing sound sources.

Preferably, the carrier module is designed to be mounted on the mainframe, or inserted in receivers of the decoupling means provided for this purpose, when it has been equipped with the items of control equipment. This therefore means, on the one hand, that the carrier module comprises a corresponding inherent stability, to be lifted in this equipped state. Preferably, corresponding lifting portions are provided for this purpose on the carrier module. This also means, however, that the carrier module as a whole is designed such that it can correspondingly encompass the mainframe. To this extent, the carrier module is thus matched to the mainframe. Additionally or alternatively, this may also be achieved in that the mainframe is correspondingly matched to the carrier means. However, the structural design of the mainframe is to a substantial extent determined by its function of carrying the generator and the aerodynamic rotor. Particularly in the case of a direct-drive wind turbine, extremely large forces have to be absorbed here, which the mainframe has to transmit towards the head of the tower, in particular towards the yaw bearing. The mainframe is designed accordingly, and the carrier module is matched to the latter.

Preferably in this case, the items of electrical equipment have already been connected up to each other, insofar as this relates to elements disposed on the carrier module, such as, for example, the generator, and connecting lines that extend down the tower to the base of the tower. Most of the connections may be already made, however. This may be effected regardless of weather conditions, at least at the installation site, in a tent, temporary workshop or the like, or already in the production workshop, the carrier module being of such a structural design that, when equipped with devices, it fits in a container. This relates to a standard shipping container, commonly known as a 20 -foot or 40 -foot container. What is important in this case is the height and width of the container, which are the same for the two containers mentioned. The length ( 20 or 40 feet) is not the limiting dimension in this case.

When the wind turbine is being installed, the carrier module has then substantially been prepared with its devices, and can be installed comparatively easily and rapidly, in particular mounted on the mainframe, which is already in situ, in particular has already been mounted on the head of the tower, or yaw bearing.

The decoupling means for carrying the carrier module on the mainframe are preferably disposed in a peripheral foot portion or foot region of the mainframe. This foot portion is disposed in a lower region of the mainframe, namely, as provided, above and close to a yaw bearing. In particular, these decoupling means are disposed in a rim-like or collar-like portion of the mainframe in which yaw drives, for effecting a yaw adjustment, are also provided, namely, on a yaw-motor receiving portion. In this case, these decoupling means, and therefore the receiving locations, are disposed in a very low region of the mainframe, such that the corresponding fastening means, such as, for example, fastening pins of the carrier module, may also be disposed down on the carrier module. As a result, the carrier module can be disposed in a very stable manner, and provide plenty of space for the items of electrical equipment.

According to one design, it is proposed that the nacelle casing (1270), the spinner casing and/or the generator casing each have a support frame (1974) and shell segments (308) accommodated therein, and in particular the shell segments are generalized, such that in each case a plurality of like shell segments are provided, and the shell segments in this case are dimensioned such that they can be accommodated for transport in 20-foot and/or 40-foot containers. The generalizing of the shell segments makes it possible to simplify the construction of the nacelle, because fewer differing parts are required and, at the same time, transport can be effected in a standardized container. As a result, the elements can be protected during transport, and there is no need for special transport provision, thereby enabling cost savings to be made. This has been made possible by the proposed division of the casing into individual portions, which accordingly can be formed by means of the generalized casing elements, particularly shell elements.

Preferably, it is proposed that the nacelle have a longitudinal axis that defines a longitudinal direction and that, in particular, corresponds to a rotation axis of the generator, and some or all of the shell elements be oriented in the longitudinal direction with two lateral longitudinal edges of the same size, a shorter and a longer transverse edge, or two like transverse edges, the transverse edges each corresponding to a segment of the circumference of the nacelle in the respective position, and the transverse edges each having a chord, namely, the distance there between the two longitudinal edges, the nacelle being divided into portions in the longitudinal direction, and the number of shell segments being selected portionally and/or the shell segments being dimensioned such that the chord of the longer transverse edge and/or, in the case of a like transverse edge, the length of the one transverse edge or of the longitudinal edge corresponding to the available inside width of a standard shipping container (20-foot or 40-foot container), such that each of these segments can be laid in the container.

The diameter of the nacelle varies in the longitudinal direction, and there is therefore a specific circumference and circumferential size for each position in the longitudinal direction. Each transverse edge of a segment, in its position, is identical with the corresponding circumference of the nacelle at that position, and ultimately the segments together form the skin of the nacelle. For this identical portion of the circumference of the nacelle and of the transverse edge there is a chord, which, namely, in the case of the transverse edge, connects the two longitudinal edges as a straight line. This chord matches the inside dimension of the shipping container. Since like segments are to be dimensioned, only discrete values are available and, accordingly, the greatest dimension that is still smaller than the inside width of the shipping container is selected. Thus if, in the selection of 6 like segments, for example, a chord dimension is obtained that is greater than the inside width of the container, accordingly more than 6 like segments must be selected. This can be calculated on the basis of this chord dimension.

One embodiment proposes that the nacelle casing have a support frame or support skeleton and shell segments accommodated therein, and, additionally or alternatively, be fastened to the carrier module and be carried thereby. The presence of such a support frame enables the nacelle casing to be of a modular design. In particular, the support frame may be constructed in a simple manner from some longitudinal and transverse ribs, in which case transverse ribs may be, in particular, transverse ribs that pass around the nacelle, about a horizontal axis. Such a support frame or rib construction then offers possibilities for accommodating corresponding shell segments. Such shell segments are prefabricated segments, for example of aluminium, and are matched to the support frame or support ribs, and are also matched in their curvature such that together they can form a substantially continuous nacelle surface.

Preferably, the nacelle is constructed such that such a support frame is fastened to the carrier module, and then this support frame accommodates the shell elements. As a result, the nacelle casing as a whole is carried by the carrier module, and is decoupled by means of the decoupling means by which the carrier module is decoupled, consequently likewise carried so as to be decoupled from the mainframe. Structure-borne sound in the mainframe, which is caused, in particular, by the rotation of the generator, can therefore not reach the carrier module, and consequently cannot reach the nacelle casing. A corresponding emission of sound by the nacelle casing is consequently avoided.

Preferably, there is additionally an elastic damped connection between the carrier module and the nacelle casing, at least partially. Such an elastically damped connection may be provided such that the support structure of the nacelle casing is rigidly fastened to the carrier module, but further support points, which provide an elastically damped connection, are provided. This avoids an excessively rigid geometry between the nacelle casing and the carrier module. Moreover, it is also possible to achieve the result that structure-borne sound that occurs in the carrier module is not transmitted, or at least is transmitted only in a damped manner, into the nacelle casing. This may also be the case for residual structure-borne sound that has still been transmitted from the mainframe into the carrier module, i.e., that could not be completely damped by the decoupling means.

According to one embodiment, it is proposed that the shell segments be produced from aluminium, in particular by a deep-drawing process. Preferably in this case, sealing lip profiles are provided, or at least one sealing lip profile per shell segment. Such a sealing lip profile may be produced, for example, by an extrusion molding process, and disposed on the shell segment. A sealing lip having a receiving portion may be inserted in, in particular pushed into, such a sealing lip profile. With such a sealing lip, the shell segment has then been fashioned in a stable manner, and can thus effect a particularly sealing joint when the nacelle casing is being assembled. This sealing joint may be effected to adjacent shell segments and/or to elements of the support structure of the nacelle casing, such as, for example, support ribs. Such a sealing lip can also protect the segments from damage during transport.

A further embodiment proposes that the nacelle casing have a tubular extension portion for enclosing an upper portion of the tower. This enclosure is provided in this case in such a way that a yaw movement of the nacelle, and therefore of the nacelle casing, and including a yaw movement of this tubular extension, remains possible. Protection against the effects of weather can thereby be achieved in a simple manner at this rotatable transition. Preferably, this tubular extension is kept as short as possible, in that a rotatable seal is provided there, in relation to the tower, that makes it possible, in particular, for the tubular portion to be only of such a length that it spans a curvature of the nacelle casing.

Similarly, a tubular extension portion may be provided on the spinner, in the region of the rotor blade connections. Accordingly, these tubular portions enclose the respective blade roots there. To that extent, it is to be noted that the spinner, which rotates with the hub and basically covers the hub, may be fastened directly to the aerodynamic rotor or electrodynamic rotor. Nevertheless, this spinner may be regarded as part of the nacelle casing, but is not directly connected to the carrier module or to the mainframe, because it rotates relative thereto.

Preferably, the spinner, or a spinner casing, this also being applicable to a generator casing, may be regarded as an element or portion that is separate from the nacelle casing. It is proposed, as an embodiment, that the spinner, or the spinner casing, be divided into a spinner main casing and a spinner cap. The spinner main casing basically encompasses most of the hub and other elements that rotate together with the hub, as a revolving shell that is open towards the front, i.e., as provided, towards the wind, and is likewise open towards the back, namely, towards the generator. The spinner main casing is tapered towards the front, leaving free a correspondingly reduced, approximately circular opening. For the latter, a spinner cap is provided, which is approximately circular in form, having a dome, i.e., in the shape of a cap. Likewise, for this cap, it is proposed that it be divided into a plurality of segments, in particular three or four segments. These segments also are to be realized such that they fit in a standard container, in particular such that they can be placed in a standard container through the door of the latter. For these segments, likewise, a chord may be defined in the region of a connection edge by which they would be fastened, or attached, to the spinner main casing, and the division of the spinner cap is to be provided such that this chord corresponds to the inside dimension of a standard container, or is somewhat smaller, in order to be laid therein. This chord of such a segment on the spinner cap is thus likewise to be realized so as to be somewhat shorter than the inside width of the container. Preferably, this chord, as also applicable to the other chords, is to be selected so as to be sufficiently short to enable it to fit transversely through an entrance door of a standard container. The calculation for this chord may also be performed in the same way as for the calculation of the other chords.

Additionally proposed according to the invention is a wind turbine having a nacelle according to at least one of the embodiments described above.

Also proposed is a method for producing a nacelle of a wind turbine. This method proposes firstly providing a mainframe, producing a carrier module, and finally mounting the carrier module on to the mainframe. This mounting is effected into coupling means, such as have already been described above. The nacelle casing may then be realized subsequently. As a result, the nacelle casing can also enclose the mainframe, this being precluded for the carrier module to the extent that the mounting of the finished carrier module on to the mainframe would thereby become impossible.

Particularly preferably, the carrier module is equipped with items of electrical control equipment before being mounted on to the mainframe. As a result, installation of items of electrical equipment in the nacelle is avoided, or kept to a minimum, when the latter is already mounted on the head of the tower. This can facilitate handling, render production less susceptible to error, and also avoid resource-intensive provision of the elements in the nacelle on the head of the tower. The elements thus do not have to be lifted individually up the wind turbine tower to the installed, or mounted, nacelle.

### BRIEF DESCRIPTION OF THE SEVERAL VIEWS OF THE DRAWINGS

The invention is described exemplarily in greater detail in the following on the basis of exemplary embodiments and with reference to the accompanying figures.

FIG. 1 shows a wind turbine, in a perspective view.

FIG. 2 shows an embodiment of a nacelle according to the invention, in a partially exploded view.

FIG. 3 shows a perspective view of a rail, having a sealing lip, produced by an extrusion molding process.

FIG. 4 shows a rail similar to that of FIG. 3, in a perspective view and in a detail view, and on a nacelle-segment shell segment that is likewise represented in a detail view.

FIG. 5 shows a part of a nacelle casing, in a partially exploded representation, with at least one shell segment according to FIG. 4.

FIG. 6 shows a mainframe, in a perspective top view.

FIG. 7 shows a detail of a mainframe according to FIG. 6, with decoupling means.

FIG. 8 shows a mainframe according to FIGS. 6 and 7, with a part of a carrier module.

FIG. 9 shows a mainframe different from that of FIGS. 6 to 8, with a part of a carrier module, in a perspective view.

FIG. 10 shows a part of carrier module partially equipped with electrical equipment items, in a perspective view.

FIG. 11 shows a carrier module, which is more extensive than that of FIG. 10, and which has likewise been equipped with electrical equipment items,

FIGS. 12 to 15 illustrate the mounting of a carrier module according to FIG. 11 on to a mainframe.

FIG. 16 shows a carrier module according to FIG. 15 mounted on a mainframe and having further receiving and decoupling elements for receiving a nacelle casing.

FIG. 17 shows a mainframe, with a carrier module according to FIG. 16 mounted thereon, with partially mounted casing.

FIG. 18 shows a mainframe with a carrier module partially mounted thereon, in a side view, with two schematically represented persons, for the purpose of explaining at least the size comparison.

FIG. 19 shows a further embodiment of a mainframe with a carrier module and partially present casing, in a perspective representation, with partially transparent casing.

FIG. 20 shows a partially exploded view of a nacelle envelope.

FIG. 21 shows an advantageous division of the elements of a nacelle envelope for transport in containers.

FIG. 22 shows a previous division of the elements of a nacelle envelope for transport.

FIG. 23 explains the mathematical division of the segments.

FIG. 24 shows a further advantageous division of the elements of a nacelle envelope for transport in a container.

### DETAILED DESCRIPTION

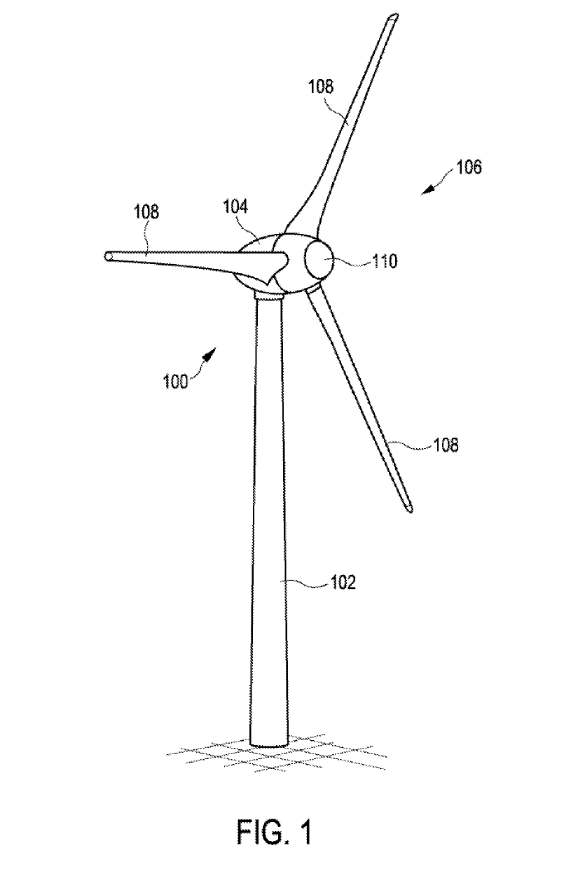

FIG. 1 shows a wind turbine 100, having a tower 102 and a nacelle 104. A rotor 106, having three rotor blades 108 and a spinner 110, is disposed on the nacelle 104. When in operation, the rotor 106 is put into a rotary motion by the wind, and thereby drives a generator in the nacelle 104.

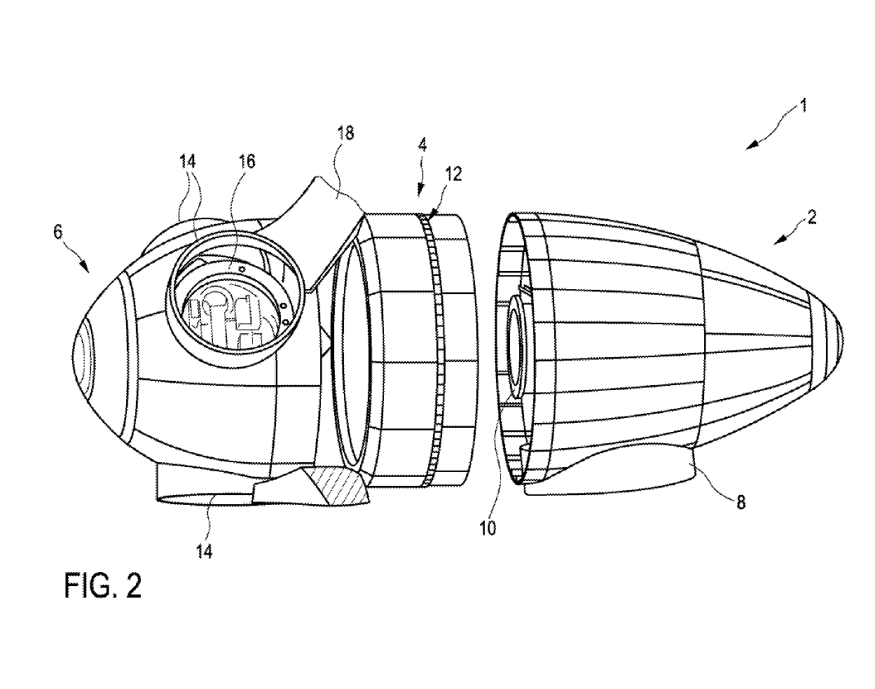

FIG. 2, in the exploded representation, explains elements of a nacelle 1 according to the invention. This nacelle has a main part 2, a stator part 4, which may also be referred to as a generator part, and a spinner 6. The main part 2 is to be disposed in the region of a tower dome 8 on a tower. The main part 2 contains many items of electrical equipment and the mainframe 10, which, in this representation, can be seen only in the region of a fastening flange.

The stator part 4, or generator part 4, is substantially cylindrical, and substantially surrounds a generator, disposed there, of a direct-drive wind turbine, for which this nacelle 1 is provided. In the case of an internal rotor, this stator part 4 may be directly connected to the stator. The generator and stator may be ventilated, for example, by means of ventilation openings 12, which, in this FIG. 2, may also be provided as a full-circumference edge, or in the region of a full-circumference edge. Here, air can flow outwards and backwards, i.e., to the right, towards the main part 2.

Represented in the spinner 6 are three blade domes 14, in the region of which rotor blades are to be connected to the hub 16. Of this hub 16, substantially a corresponding fastening flange, for fastening a rotor blade, can be seen through the opening of a blade dome 14. Also represented, on each blade dome 14, is a blade extension 18, which is realized such that it complements the respective rotor blade in its shape when the corresponding rotor blade is in its operating state without being rotated out of the wind. This therefore relates to a wind turbine having rotor blades with blade pitch control. The said operating position is, in particular, that assumed by the rotor blades in the partial-load range.

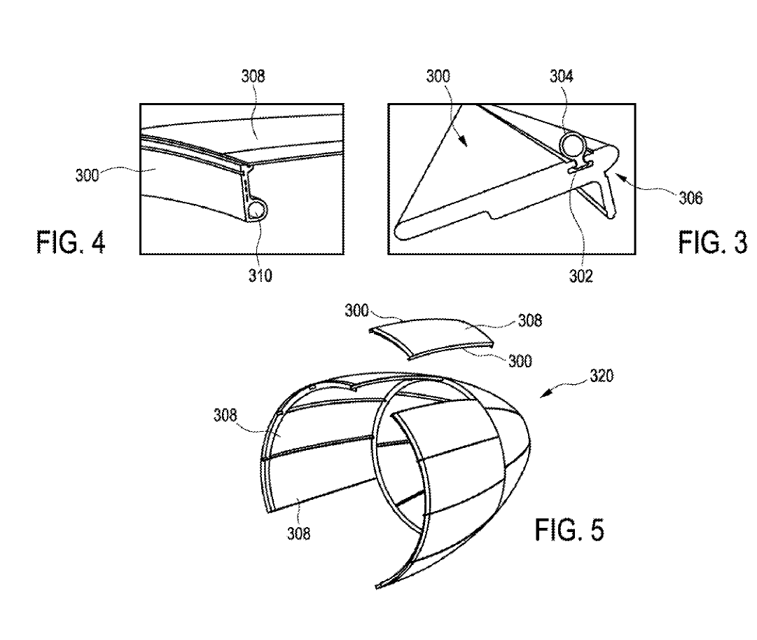

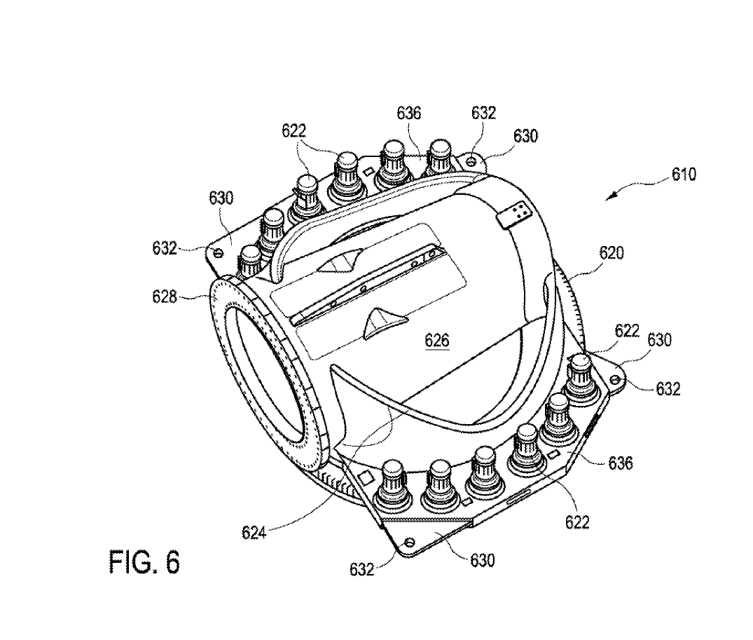

FIG. 3 shows an extrusion-molded rail 300 of aluminium, which shows a sealing lip groove 302 with a sealing lip 304 inserted therein. This rail 300 has a fastening region 306, in which fastening to a casing segment 308, or shell segment 308, which is represented in a detail view in FIG. 4, is to be effected. In this case, as shown in FIG. 4, the rail 300 may have a further stabilizing portion 310.

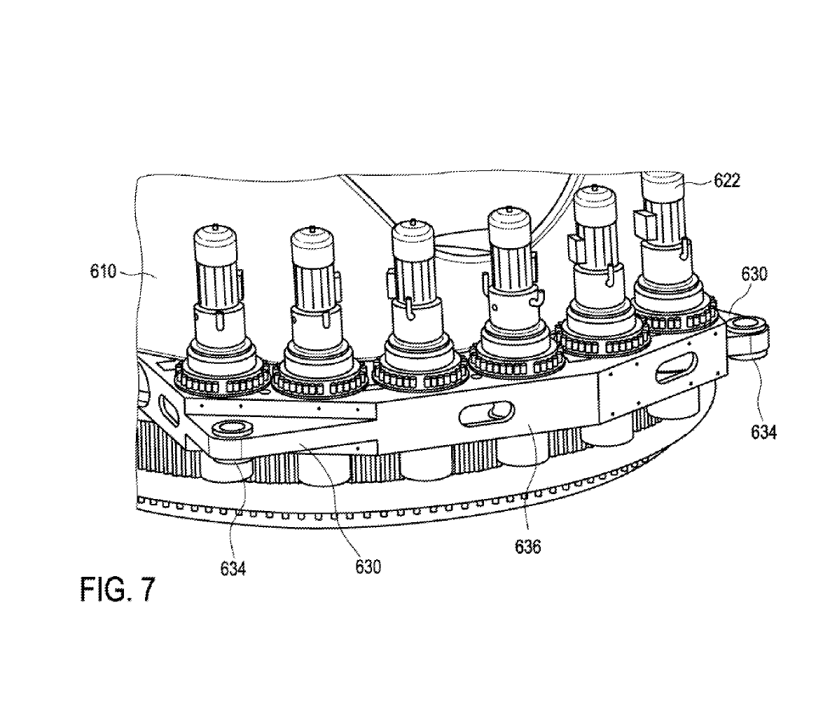

FIG. 5 shows a part of a nacelle, in particular a part of a main part 320, which, in the exploded-type representation, also separately shows a casing segment 308. Provided on this casing segment 308 are two rails 300, to be disposed in a sealing manner on adjacent casing segments 308.

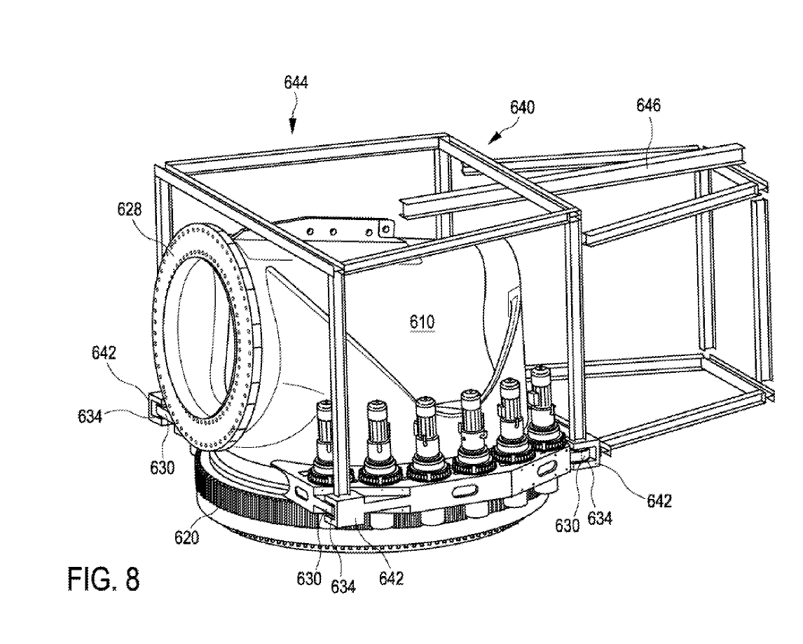

FIG. 6 shows a mainframe 610, as well as a yaw crown, relative to which the mainframe 610 is designed to rotate. Provided here to initiate the rotary motion are 12 yaw motors 622, which act upon the yaw crown. The mainframe 610 shown is basically composed of two approximately tubular sub-portions 624 and 626, and the tubular portion 626 has a fastening flange 628 for fastening a generator, or for fastening an axle pin for carrying the generator. When the wind turbine is in the assembled state, the weight force of the generator, that of the aerodynamic rotor, and some further forces that occur there must be transmitted from this fastening flange 628, via these two tubular portions 624 and 626, to the yaw crown, or to a yaw bearing not specified in greater detail here. All noises that occur in this case, in particular structure-borne sound produced by the generator, are passed into the mainframe 610 via this fastening flange 628.

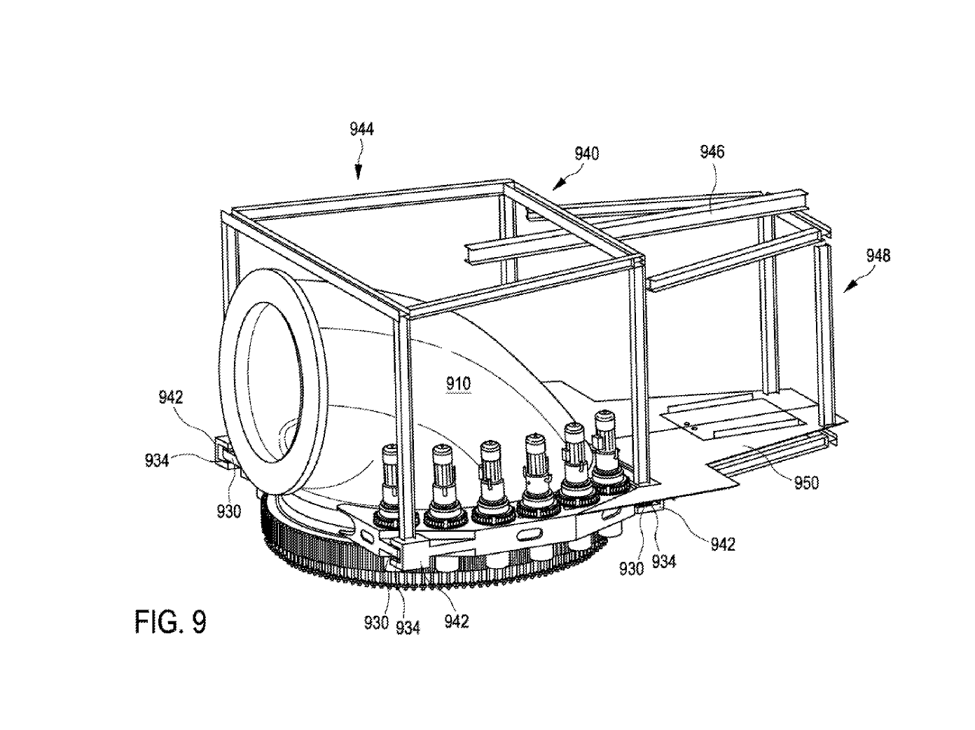

For the purpose of receiving a carrier module, this mainframe 610 has corresponding module receivers 630. Such module receivers 630 may be lugs or brackets. In particular, when this mainframe 610 is being cast as a steel casting, these module receivers 630 may be cast on concomitantly. These module receivers additionally have receiving bores 632, which can receive decoupling means, as illustrated in FIG. 7.

FIG. 7 shows a detail of FIG. 6 in a different perspective, and in this case shows two of the module receivers 630, which are provided there as lugs. Seated in the receiving bores 632, which are no longer directly visible in FIG. 7, there are then decoupling means 634, which are provided there as elastically damping inserts, which may be composed, for example, of a rubber or hard rubber, or comprise such. What is crucial is their position, and therefore also the position of the receiving bores 632 and, accordingly, of the module receivers 630, for receiving and carrying a carrier module in this region, which is to be described in the following. That is to say, these module receivers 630 are disposed on a lower peripheral base portion 636 of the mainframe 610. In the exemplary embodiment shown, this is simultaneously a receiving region 636 for yaw motors.

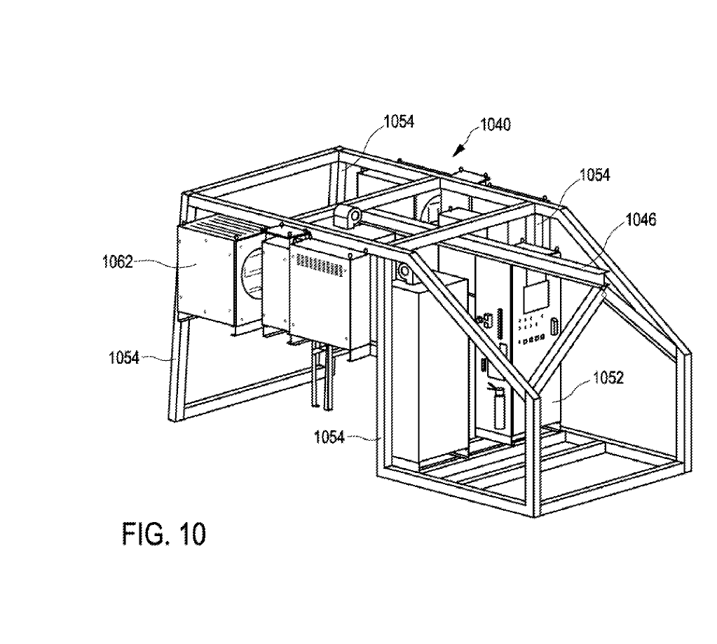

FIG. 8, in relation to the mainframe of FIGS. 6 and 7, shows the arrangement of a part, albeit an essential part, of a carrier module 640. By means of decoupling portions 642, in the region of the module receiver 630, this carrier module 640 is fastened to this region by means of the decoupling means 634. Corresponding to the positions shown in FIG. 6, there are four such decoupling portions 642 provided, which to that extent may be referred to as fastening portions 42. The representation of FIG. 8 shows only three of these regions, in which the carrier module 640 is fastened to the module receivers 630, and consequently to the mainframe 610, by means of the fastening portions 42 and the decoupling means 634.

The carrier module 640 is thus fixedly connected to the mainframe 610, but at the same time is fully decoupled against the transmission of structure-borne sound. The carrier module 640 in this case may have a basic portion 644, which substantially surrounds the mainframe 610, or the two tubular portions 624 and 626. This basic portion 644 is fastened to the mainframe 610 by means of the decoupling means 634 described. The basic portion 644 then has a rear portion 648, as an extension and also for accommodating a crane girder 646.

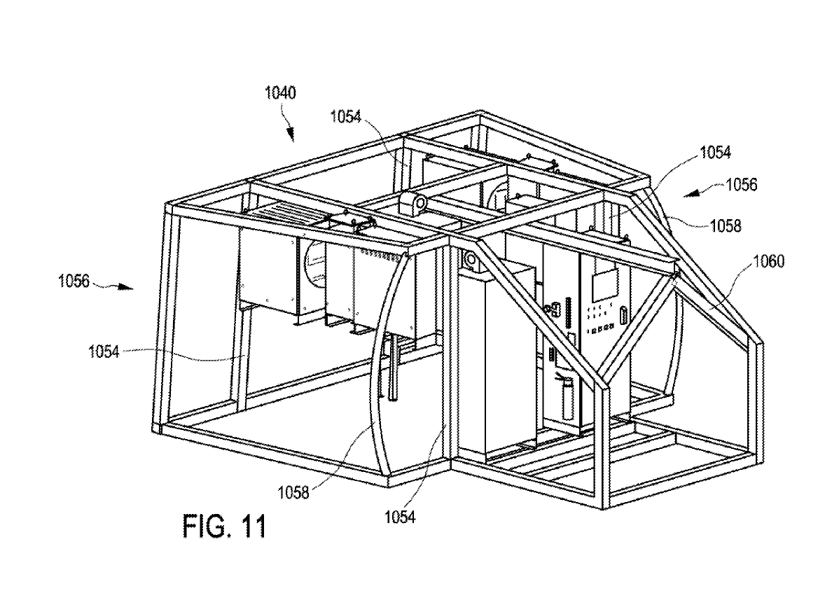

FIG. 9, in a manner very similar to FIG. 8, shows a mainframe 910, having a carrier module 940 that has a basic portion 944 and a rear portion 948, including a crane girder 946. Here likewise, in a manner very similar to that shown in FIG. 8, fastening with decoupling is effected by fastening portions 942, by means of decoupling means 934, which are scarcely visible, however, to module receivers 930 of the mainframe 910. In other respects, also, the carrier modules of FIGS. 9 and 8 are very similar. The carrier module 940 of FIG. 9 also additionally shows base plates 950, which, however, likewise also provided for the carrier module 640 according to FIG. 8, are merely not represented in FIG. 8.

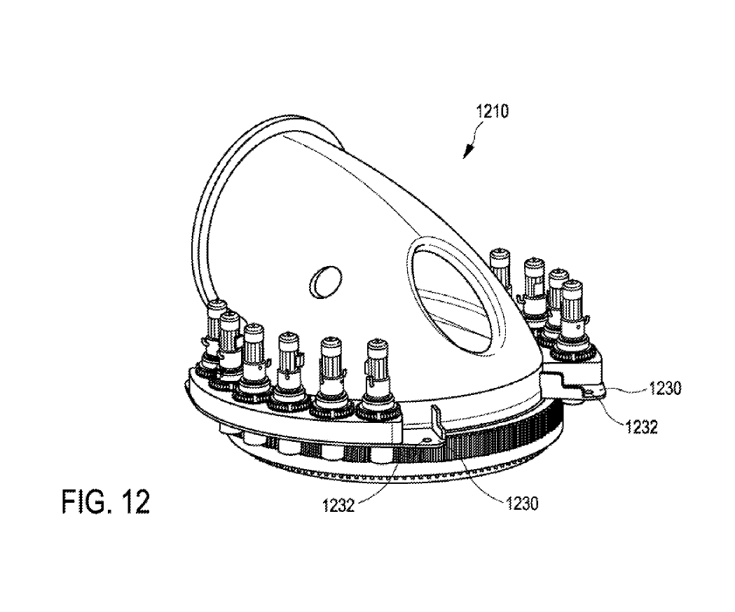

FIG. 10 then shows a part of a carrier module 1040, which is similar in structure to the carrier modules of FIGS. 8 and 10, merely differing somewhat in the region of the crane girder 1046. This carrier module 1040 has been equipped with various items of electrical equipment, such as control cabinets 1052. The carrier module 1040 has four main supports 1054, which are to be mounted on a mainframe by means of decoupling means and corresponding module receivers. This is to be explained in subsequent figures.

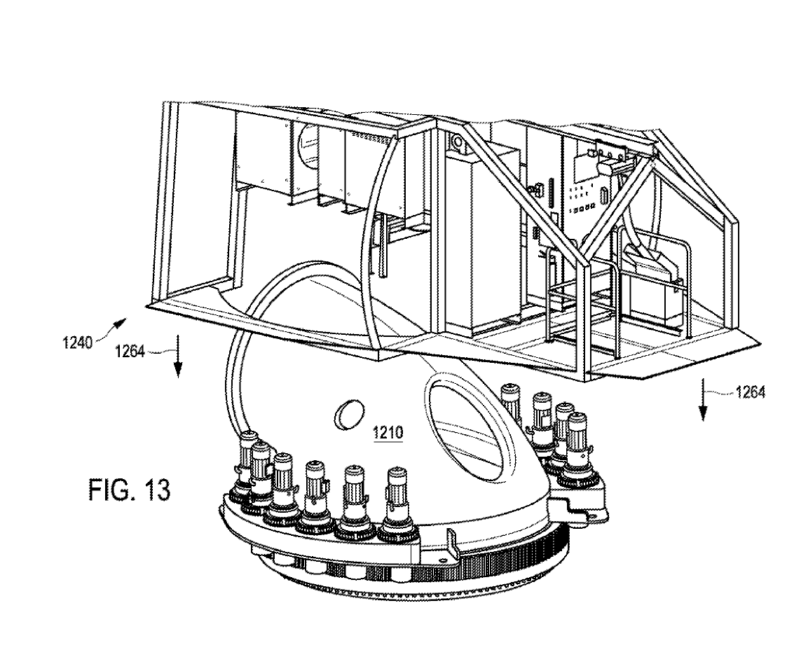

FIG. 11 shows, in comparison with FIG. 10, lateral extensions 1056, that have already been partially matched to a nacelle casing, i.e., an outer form of the nacelle to be produced. Shown particularly clearly by these extensions are the two bent struts 1058, but also the fact that the now shown construction of the carrier module 1040 extends rearwards, namely, to the two support struts 1060, which are joined together at an angle and support the crane girder 1046 there.

The part of the carrier module 1040 shown in FIG. 10, including the represented equipping with items of electrical equipment, such as the switchgear cabinet 1052, is dimensioned in respect of its size such that it fits in a conventional transport container for road transport. This part according to FIG. 10, having been equipped as shown, can thus be transported in such a normal container to a destination. The provision of equipment may also be already performed in the workshop, including the electrical connection of the elements, insofar as possible. The extension that is shown in FIG. 11 is also to be provided for the part of the carrier module 1040 according to FIG. 10. This, however, may be effected at the erection site, if this standard container is used for transport. It must also be pointed out that, for example, the electrical module 1062 projects out laterally beyond the main supports 1054. However, this projection is of such a size that still fits in the said standard containers.

Alternatively, in the case of transport by means of a heavy freight vehicle, the carrier module 1040 with the lateral extension 1056, as shown in FIG. 11, can be accommodated completely in a corresponding container of a heavy freight transport system. Thus, if a heavy freight vehicle is used for transport, the carrier module 1040 can clearly also be prepared with the provision of the electrical elements, but additionally also with these lateral extensions, in the workshop and transported, as shown, to the installation site.

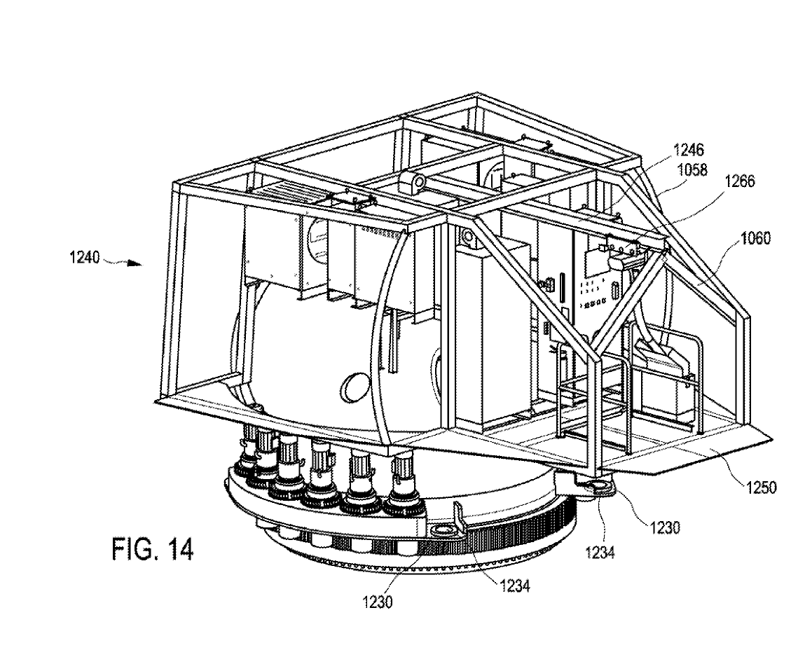

FIGS. 12 to 15 then illustrate the mounting of the carrier module 1040, including the lateral extension 1056 according to FIG. 11, on to a mainframe 1210. The mainframe 1210 is very similar in design to the mainframe 910 according to FIG. 9, but differs in some details in the region of the module receiver 1230, including receiving bores 1232. FIG. 12 to this extent shows the prepared mainframe 1210, and FIG. 13 shows a first position, in which the carrier module 1240 is already being delivered and lowered by a crane. Two lowering arrows 1264 indicate the direction of lowering of the carrier module 1240 on to the mainframe 1210.

FIG. 14 then illustrates, with the carrier module 1240 having been lowered further and now shown fully, the provision of four decoupling means 1234, of which only two are represented, however, owing to the perspective, which are now accordingly disposed in the region of the module receivers 1230.

Besides this, the carrier module 1240 also shows base plates 1250, as well as some further details such as, for example, a crane element 1266 on the crane girder 1246. These elements are not necessary for implementing the structure illustrated here, but it is advantageous for these elements to be already pre-installed. The carrier module 1240 is thus prefabricated and equipped, including electrical interconnections of the electrical equipment items present, insofar as this is already possible, and including the base plates 1250.

FIG. 15 then shows the finished state of the construction of the mainframe 1210 and the carrier module 1240.

It can now also be seen from FIGS. 12 to 15 that the carrier module 1040 is mounted, in the region of the main supports 1254, on the module receivers 1230 and the decoupling means 1234.

Thus, not only can these elements be assembled comparatively easily, in that especially the carrier module 1240 is prepared and equipped insofar as possible, and only then is mounted, but in this case it is possible at the same time to achieve a structure with reduced sound, i.e., in which structure-borne sound is not transmitted from the mainframe 1210, or is transmitted only slightly, to the carrier module 1240, from which it might be able to pass into a casing from which it could be emitted. This is prevented, or at least considerably reduced.

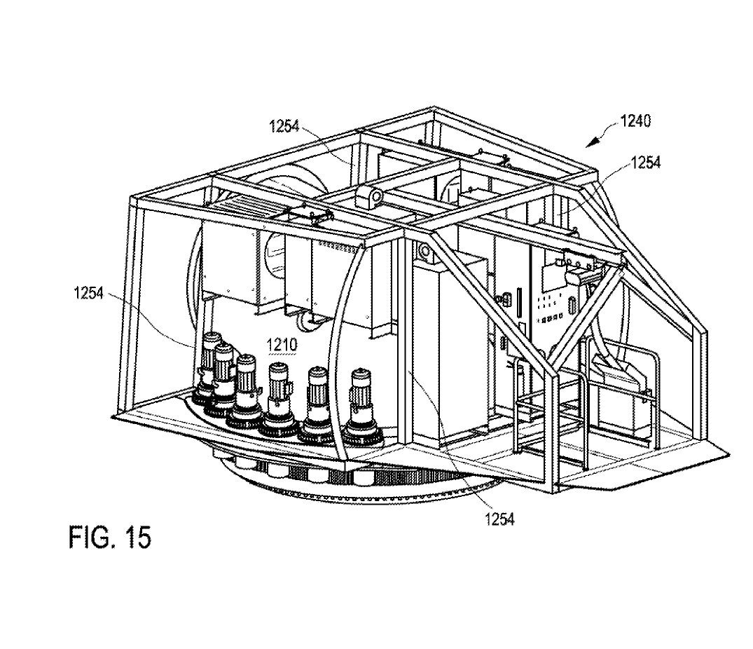

FIG. 16 now shows the addition of decoupling supports 1268 for fastening, and decoupling supports of a nacelle casing. These decoupling supports are attached at a later stage, since, in the pre-installed state, there is no more room for them in the transport container, not even in the heavy-freight transport container. However, these decoupling supports 1268 are few in number, and they can be mounted comparatively easily in situ, in order then to provide the nacelle casing. It is pointed out that installing the items of electrical equipment can be particularly resource-intensive, complicated and possibly susceptible to error, because a wide range of functional tests should or must be performed for the items of electrical equipment. Many of these functional tests can now be already effected in a workshop, before transport.

Such considerations, in particular tests, are not required for the decoupling supports 1268, such that they can be installed, or mounted, in situ comparatively easily and in an unproblematic manner.

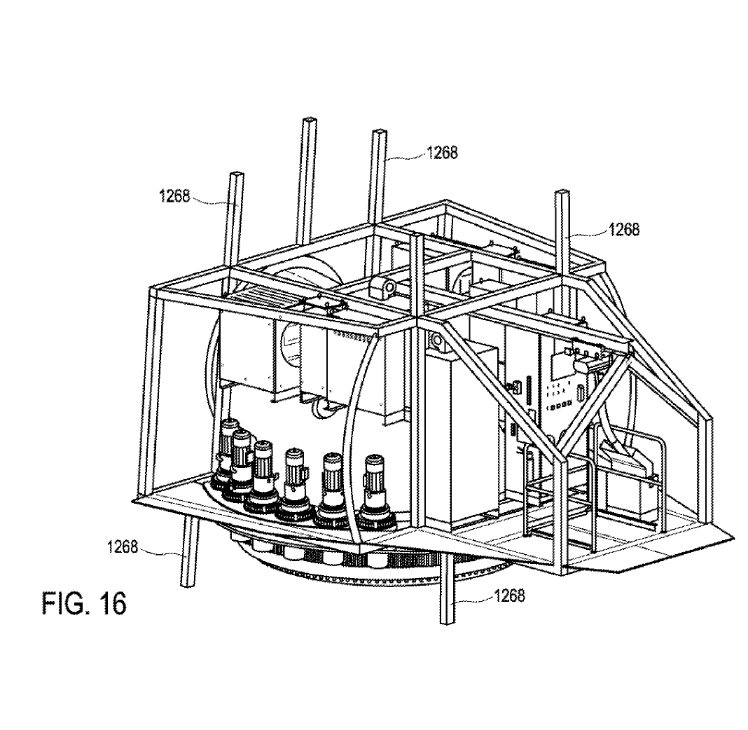

FIG. 17 then shows a part of a nacelle casing of a main part 1202 of a nacelle. It can be seen that some of the decoupling supports 1268 project through the casing 1270. Nevertheless, they can partially support the casing 1270, and they can be used for mounting external elements such as, for example, navigation lights or measuring instruments such as anemometers. FIG. 17 additionally shows a tower dome 1208, which is provided in the region towards a tower. The tower dome 1208 here is of a comparatively short design, and is able to be so short because ventilation of the nacelle is not effected via this region of the tower dome 1208, such that the latter can be substantially sealed off in respect of the tower, and accordingly no flow paths need be provided for inflowing air.

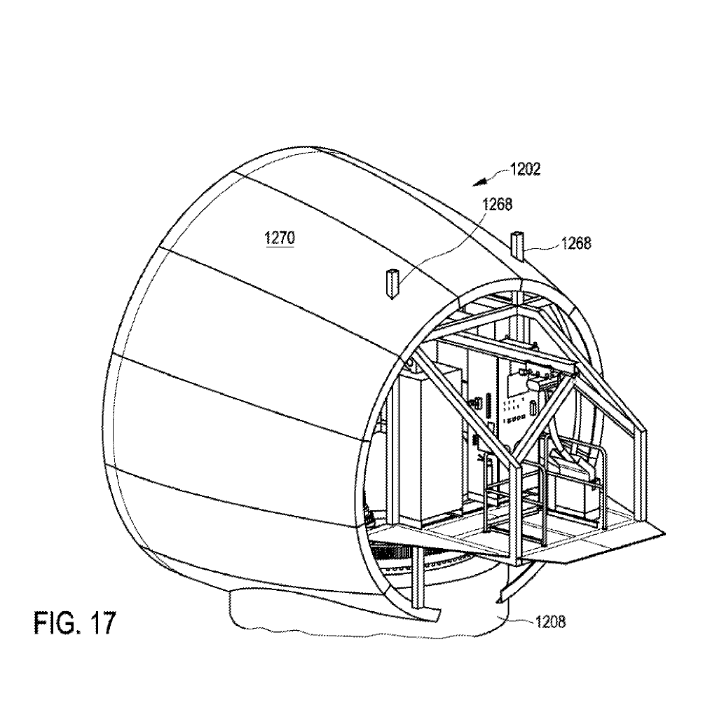

FIG. 18 illustrates an assembly of a mainframe 1210 and a carrier module 1240, and the persons 1272 illustrated indicate, not only the size of the structure, but also where there are standing surfaces for access.

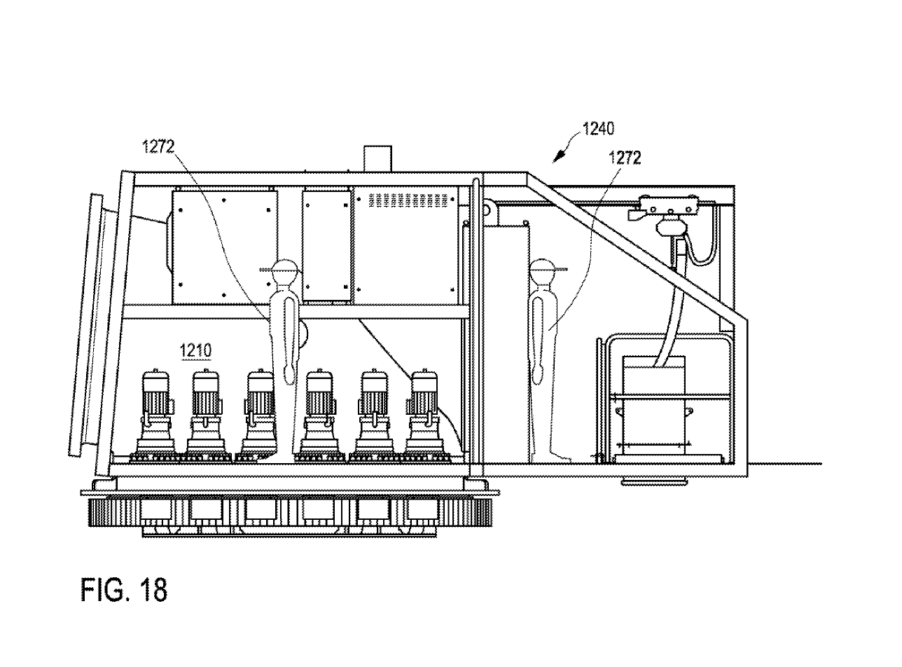

FIG. 19, in a perspective representation, shows a mainframe 910 with a mounted and completely equipped carrier module 940, which, according to the drawing is at least partially accommodated in a nacelle casing. The nacelle casing 1970 in this case has full-circumference ribs 1974 and, disposed longitudinally between them, ribs 1976. These may form a skeleton or support carcass for the nacelle casing 1970, or the longitudinal ribs may be part of the casing segments 1987.

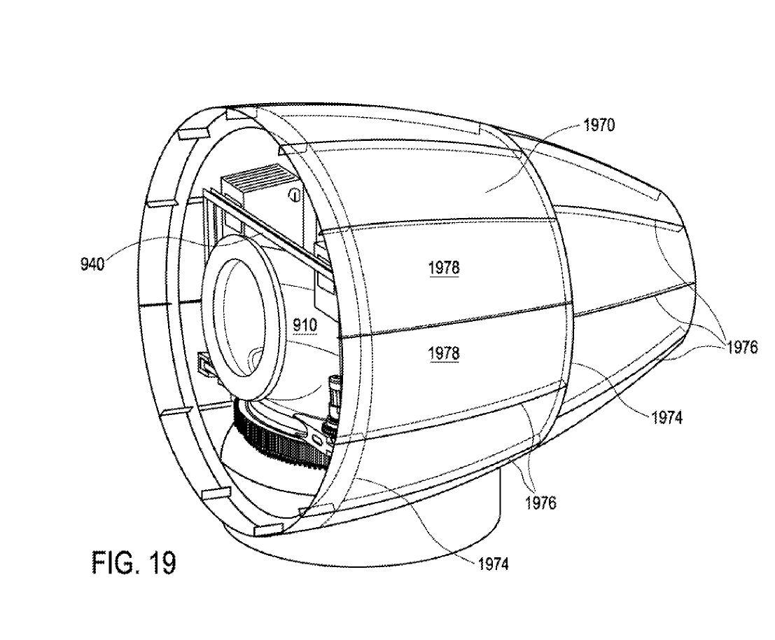

FIG. 20, in the exploded representation, thus shows a nacelle 2001, of which only the envelope is represented here. This envelope or nacelle envelope is composed of essentially three regions, namely, the nacelle casing 2002, the generator casing 2004 and the spinner casing 2006. The nacelle casing 2002 is divided into a front nacelle casing 2020, a rear nacelle casing 2022, and a closing-off nacelle cap 2024 right at the back.

The spinner casing 2006 is further divided into a spinner main casing 2060 and a spinner cap 2062. The generator casing 2004 is not divided further in the longitudinal direction, i.e., from the nacelle cap 2024 to the spinner cap 2062.

Apart from the two caps, i.e., the nacelle cap 2024 and the spinner cap 2062, the individual casing portions have been divided, insofar as possible, into individual lengthwise segments, each being the shell segments. The division into lengthwise segments is effected insofar as possible, and in this case is interrupted only in the spinner main casing 2060, in the region of the blade bushings or blade domes 2064, and the front nacelle casing 2020 is interrupted in the region of the tower bushing, or tower dome 2026. Otherwise, lengthwise segments that are alike are used in each case.

For this purpose, the rear nacelle casing 2022 has eight rear nacelle segments 2028. The front nacelle casing 2020 has nine front nacelle segments 2030, and the generator casing 2004 has been divided into eight generator segments 2042. Between the blade domes 2064, the spinner main casing 2060 has a respective spinner segment 2066. Thus, in total, there are three spinner segments 2066.

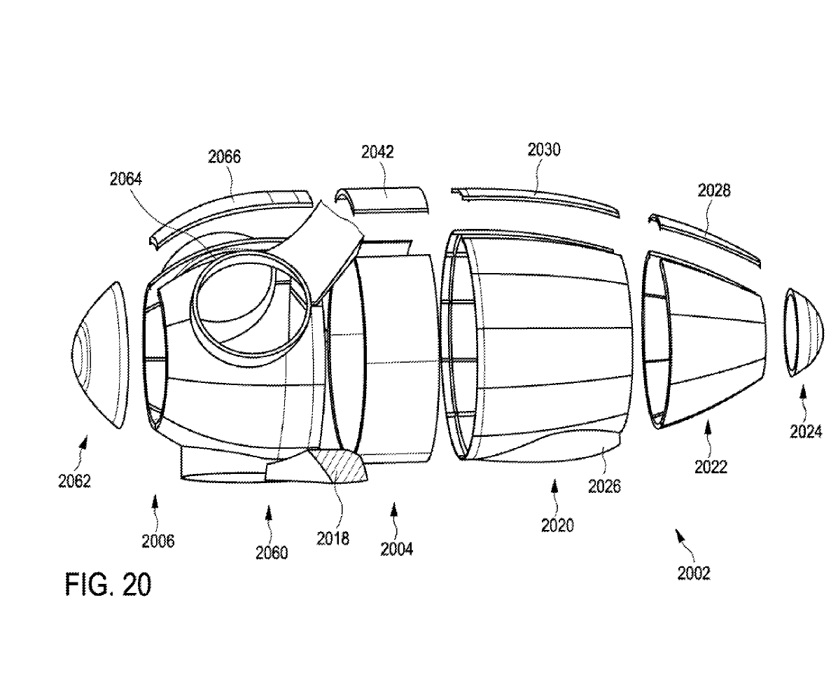

FIG. 21 shows six 20-foot containers 2080 and one 40-foot container 2084. All elements represented in FIG. 20, apart from the two caps, are contained in this total of seven containers. A separate transport frame 2086 has been provided for the nacelle cap 2024 and the spinner cap 2062. Also additionally represented, on the spinner main casing 2060 according to FIG. 20, are three blade extension 2018, which are designed such that they complement the respective rotor blade in its shape when it is in its operating state, without being turned out of the wind, i.e.,, in particular, in the partial-load range, or partial-load operating mode. These blade extension 2018 are demountable, and when in the demounted state can be accommodated in a container, as shown by FIG. 21.

Otherwise, in one of the four containers represented in a row in FIG. 21, the rear nacelle segments 2028 are stored in a stack. The front nacelle segments 2030 are stored in two further containers. Segments comprising the tower dome 2026 are stored in another, further container.

The container in which the demountable blade extensions 2018 are already stored also contains the generator segments 2042.

The only long container, the 40-foot container 2084, contains all blade dome segments 2064. Finally, the three spinner segments 2066 are accommodated in the final container 2080, which has not yet been explained.

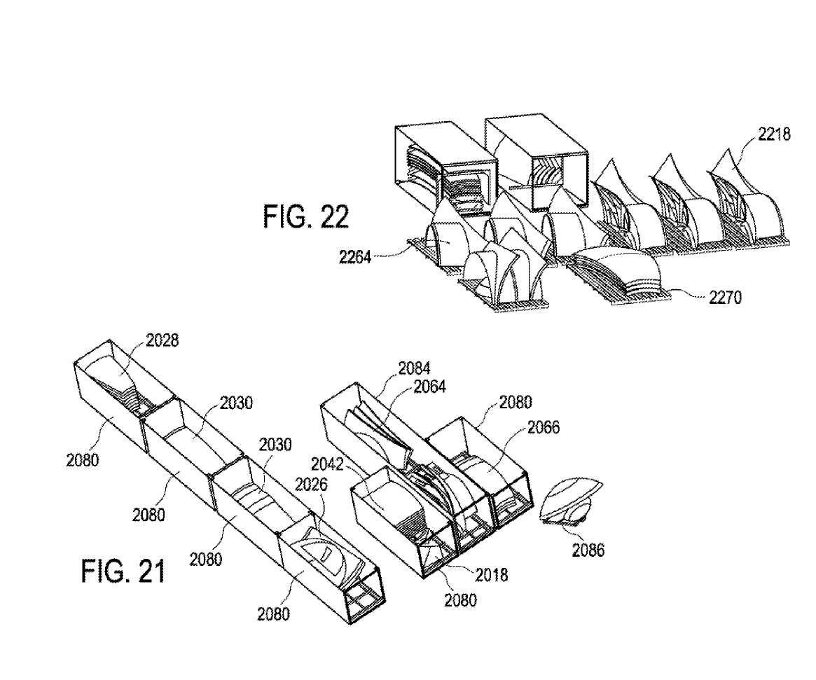

FIG. 22, for comparison, shows a previous manner of transport, in which two 20-foot containers are also provided, but in which remaining components have to be transported on transport pallets. This is also due to the fact, not least, that it was necessary to transport segments having non-demountable blade extensions 2218. Moreover, the dome segments 2264 are difficult to transport, owing to the long domes. In addition, the unfavorable division of other segments makes it necessary to effect such transport on pallets 2270.

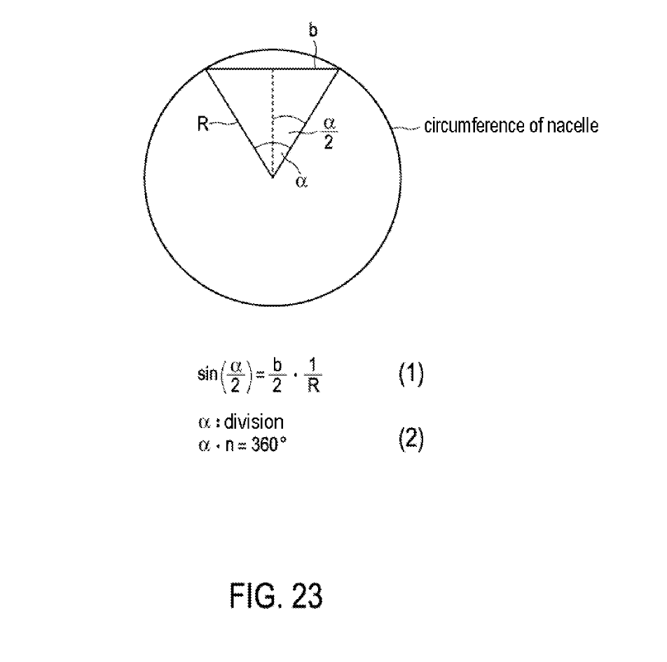

FIG. 23 explains the mathematical division of the segments. Accordingly, the following relationship exists between the chord b, the radius R and the division a:

$$sin ( \frac{α}{2} ) = \frac{b}{2} \times \frac{1}{R}$$

Moreover, the number of segments, assuming that the latter form a complete circle, multiplied by the angle α, must result in 360°:
α: division
α:n=360°

The number n is to be selected such that the chord length b, according to the two equations (1) and (2) still fits in the shipping containers, i.e., is somewhat smaller than the inside width.

The result for FIG. 20, if there were no dome segments to be taken into account, is 9 segments having a division of 40° for the spinner segments 2066 of the spinner main casing 2060, 12 segments having a division of 30° for the front nacelle segments 2030 of the front nacelle casing 2020, and 8 segments having a division of 45° for the rear nacelle segments 2028 of the rear nacelle casing 2022.

The domes in this case do not alter the division, but only the number of like segments in each case.

In particular, the segments must fit through an opening width of the door of the container. This is 2.343 meters, and the height of the door opening is 2.28 meters.

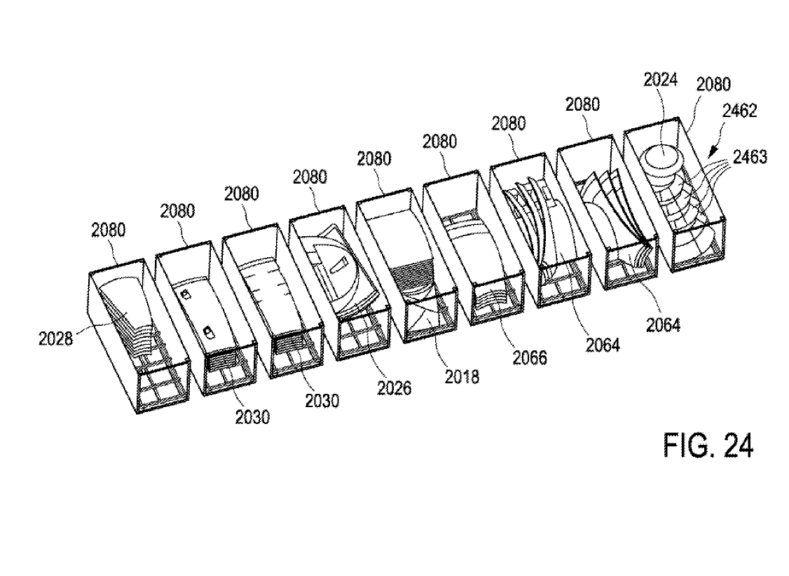

FIG. 24 corresponds in many details to the representation of FIG. 21. To that extent, reference is made to this FIG. 21 and to the explanations relating thereto. To that extent also, many of the references are identical. Unlike the embodiment of FIG. 21, FIG. 24 shows an embodiment in which a spinner cap 2462 has been divided into four spinner cap segments 2463 and, disassembled for transport, disposed in the container 2080 represented on the right, for transport. The nacelle cap 2024 is also disposed in the same container 2080 with these spinner cap segments 2463.

In addition, this embodiment according to FIG. 24 provides that only 20-foot containers 2080 be used, such that it has been possible to replace the 40-foot container 2084 of FIG. 21 by two 20-foot container 2080. There are now nine 20-foot containers provided, and it has then also been possible to dispense with the separate transport frame 2086 that is represented in FIG. 21. All elements of the nacelle envelope are now accommodated in nine 20-foot containers, and can therefore be transported satisfactorily, and in particular with good protection against the effects of weather. This can also avoid any damage resulting from transport, the risk of which can at least be reduced.

1. A nacelle of a wind turbine, the wind turbine having a generator for generating electrical energy from wind, and the nacelle comprising:
a mainframe for carrying the generator on a tower,
a carrier module for accommodating items of electrical control equipment, and
a nacelle casing for protecting the carrier module and the mainframe against effects of weather,
at least one of the carrier module and/or and the nacelle casing being connected to the mainframe by decoupling means such that there exists thereby an elastically damped connection to the mainframe.

2. The nacelle of a wind turbine according to claim 1, wherein at least one of the following:
the nacelle casing is connected to the carrier module by decoupling means,
a spinner casing is fastened to a rotor of the generator or a generator-rotor by decoupling means,
a generator casing is fastened to a stator of the generator by decoupling means, and
the spinner casing has a separable blade extension for each rotor blade.

3. The nacelle of a wind turbine according to claim 1, wherein the carrier module is carried by the mainframe by the decoupling means, wherein the decoupling means reduce an amount of structure-borne sound from being transmitted from the mainframe to the carrier module.

4. The nacelle of a wind turbine according to claim 1, wherein the carrier module and/or and the mainframe are designed for the carrier module to be mounted on the mainframe and inserted in receivers of the decoupling means.

5. The nacelle of a wind turbine according to claim 1, wherein the decoupling means for fastening the carrier module in a peripheral region of the mainframe are disposed close to a yaw bearing in a portion that al-so-accommodates yaw drives for effecting a yaw adjustment.

6. The nacelle of a wind turbine according to claim 2, wherein at least one of the nacelle casing, the spinner casing, and the generator casing have a support frame and shell segments accommodated therein.

7. The nacelle of a wind turbine according to claim 6, wherein the nacelle has a longitudinal axis that defines a longitudinal direction and that corresponds to a rotation axis of the generator, and at least some of the shell elements are oriented in the longitudinal direction with two lateral longitudinal edges of equal size, a shorter and a longer transverse edge, or two transverse edges, the two transverse edges, each corresponding to a segment of the circumference of the nacelle in the respective position, and the two transverse edges, each having a chord, the nacelle being divided into portions in the longitudinal direction, and a number of shell segments being selected and dimensioned such that the chord of the longer transverse edge corresponds to an inside width of a standard shipping container, such that each of shell segments are configured to fit in the container.

8. The nacelle of a wind turbine according to claim 1, wherein the nacelle casing is connected to the carrier module and is carried thereby.

9. The nacelle of a wind turbine according to claim 1 comprising an elastically damped connection between the carrier module and the nacelle casing.

10. The nacelle of a wind turbine according to claim 6, wherein each of the shell segments include aluminum and at least one sealing lip profile for receiving a sealing lip for the purpose of being assembled in a sealing manner with other shell segments.

11. The nacelle of a wind turbine according to claim 1, wherein the nacelle casing has a tubular extension portion for enclosing an upper portion of the tower, the nacelle comprising a spinner portion, that encloses a rotor hub and has a tubular extension portion for enclosing a root region of a rotor blade.

12. The nacelle of a wind turbine according to claim 2, wherein the spinner casing has a spinner main casing, wherein disposed on the spinner main casing is a spinner cap for closing the spinner main casing, the spinner cap being divided into a plurality of segments.

13. A wind turbine, having comprising a nacelle according to claim 1.

14. A method for producing a nacelle of a wind turbine, comprising the steps:
providing a mainframe,
producing a carrier module for accommodating items of electrical control equipment, and
mounting the carrier module on to the mainframe by decoupling means.

15. The method according to claim 14, wherein the carrier module is equipped with items of electrical control equipment before being mounted on to the mainframe.

16. The nacelle of a wind turbine according to claim 6, wherein the shell segments are dimensioned to be accommodated for transport in at least one of 20-foot and 40-foot containers.

17. The nacelle of a wind turbine according to claim 7, wherein the container is 40 feet or less.
